(19) United States
(12) Patent Application Publication
(10) Pub. No.: US 2018/0174027 A1
(43) Pub. Date: Jun. 21, 2018

(54) MULTI-COMPARTMENT DENDRITES IN NEUROMORPHIC COMPUTING

(71) Applicant: Michael I. Davies, Portland, OR (US)

(72) Inventor: Michael I. Davies, Portland, OR (US)

(21) Appl. No.: 15/385,038

(22) Filed: Dec. 20, 2016

(51) Int. Cl. G06N 3/063; G06N 3/04; G06N 3/08

(52) U.S. Cl. CPC G06N 3/063; G06N 3/08; G06N 3/049

(57) ABSTRACT

An electronic neural core circuit is provided, comprising a processor, and a memory. The memory comprises a plurality of neural compartments, each compartment comprising a first state variable representing a first state of the neural compartment, and a second state variable representing a second state of the neural compartment. The processor is configured to, for a first neural compartment: receive a synaptic input, perform first and second state variable operations, join operations utilizing input from state variables from another compartment that has been previously processed, thereby producing a join operation results, and produce a state variable output.

### TECHNICAL FIELD

The present disclosure relates to devices and methods for operating a neuromorphic processor of a neuromorphic computing system comprised of neuromorphic cores.

### BACKGROUND

A neuromorphic processor is a processor that is structured to mimic certain aspects of the brain and its underlying architecture, particularly its neurons and the interconnections between the neurons, although such a processor may deviate from its biological counterpart. A neuromorphic processor may be comprised of many neuromorphic (neural network) cores that are interconnected via a bus and routers which directs communications between the cores. This network of cores may communicate via short packetized spike messages sent from core to core. Each core may implement some number of primitive nonlinear temporal computing elements (neurons). When a neuron's activation exceeds some threshold level, it may generate a spike message that is propagated to a fixed set of fan-out neurons contained in destination cores. The network then may distribute the spike messages to all destination neurons, and in response, those neurons update their activations in a transient, time dependent manner.

It is desirable to create an efficient and fast neuromorphic processor that borrows from the biological model where practical, but deviates from the biological model when it is advantageous to do so.

### BRIEF DESCRIPTION OF THE DRAWINGS

FIG. 1A is a high-level block diagram of a model neural core structure, according to an example;

FIG. 1B is a pictorial diagram that illustrates one configuration of a multi-compartment neurons and a dendritic accumulation process, according to an example;

FIG. 1C is a pictorial diagram that shows a state structure of multiple compartments, according to an example;

FIG. 2A is a block diagram illustrating state dynamics for a dendritic compartment according to a simple neuron model, according to an example;

FIG. 2B is a block diagram illustrating state dynamics and the dendritic accumulation process for a dendritic compartment according to a multi-compartment neuron model, according to an example;

FIG. 2C is a block diagram that illustrates an E/I neuron, according to an example;

FIG. 3A is a pictorial diagram of a structural models that may be used for a dendritic compartment, according to an example;

FIG. 3B is a pictorial diagram illustrating the inputs and outputs of a dendritic compartment, according to an example;

FIGS. 3C and 3D are pictorial diagrams of dendritic trees, according to an example;

FIG. 4 is a flowchart illustrating a method for processing a dendritic compartment, according to an example; and

FIG. 5 is a block diagram illustrating a machine or system within which a neuromorphic core may be used, according to an example.

### DETAILED DESCRIPTION

The following is a detailed description of various embodiments and configurations depicted in the accompanying drawings. However, the amount of detail offered is not intended to limit anticipated variations of the described configurations; to the contrary, the claims and detailed description are to cover all modifications, equivalents, and alternatives falling within the spirit and scope of the present teachings as defined by the claims. The detailed descriptions below are designed to make such configurations understandable to a person having ordinary skill in the art.

The following describes a system and method in which compartment configuration is programmed such that the same basic sequential processor circuit implementation may be used for a very wide variety of neural computational models, providing a highly efficient solution. This system may leverage a sequential state processing mechanism inherent in an efficient silicon neuromorphic implementation to transport information from one neural unit to the next in the same way that dendritic compartments transport current/voltage information to their neighbor(s).

An extension of this architecture is disclosed in a concurrently-filed patent application by Applicant, titled “SCALABLE NEUROMORPHIC CORE WITH SHARED SYNAPTIC MEMORY AND VARIABLE PRECISION SYNAPTIC MEMORY” and identified by docket identifier 884.Z67US1, herein incorporated in its entirety by reference.

As used herein, references to “neural network” for at least some examples is specifically meant to refer to a “spiking neural network”; thus, many references herein to a “neuron” are meant to refer to an artificial neuron in a spiking neural network. It will be understood, however, that certain of the following examples may also apply to other forms of artificial neural networks.

In an example of a spiking neural network, activation functions occur via spike trains, which means that time is a factor that has to be considered. Further, in a spiking neural network, each neuron is modeled after a biological neuron, as the artificial neuron receives its inputs via synaptic connections to one or more “dendrites” (part of the physical structure of a biological neuron), and the inputs affect an internal membrane potential of the artificial neuron “soma” (cell body). In a spiking neural network, the artificial neuron “fires” (e.g., produces an output spike), when its membrane potential crosses a firing threshold. Thus, the effect of inputs on a spiking neural network neuron operate to increase or decrease its internal membrane potential, making the neuron more or less likely to fire. Further, in a spiking neural network, input connections may be stimulatory or inhibitory. A neuron's membrane potential may also be affected by changes in the neuron's own internal state (“leakage”).

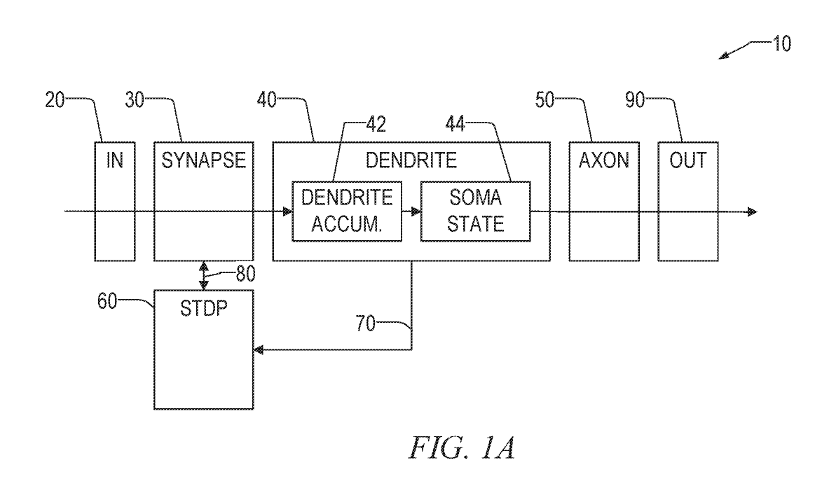

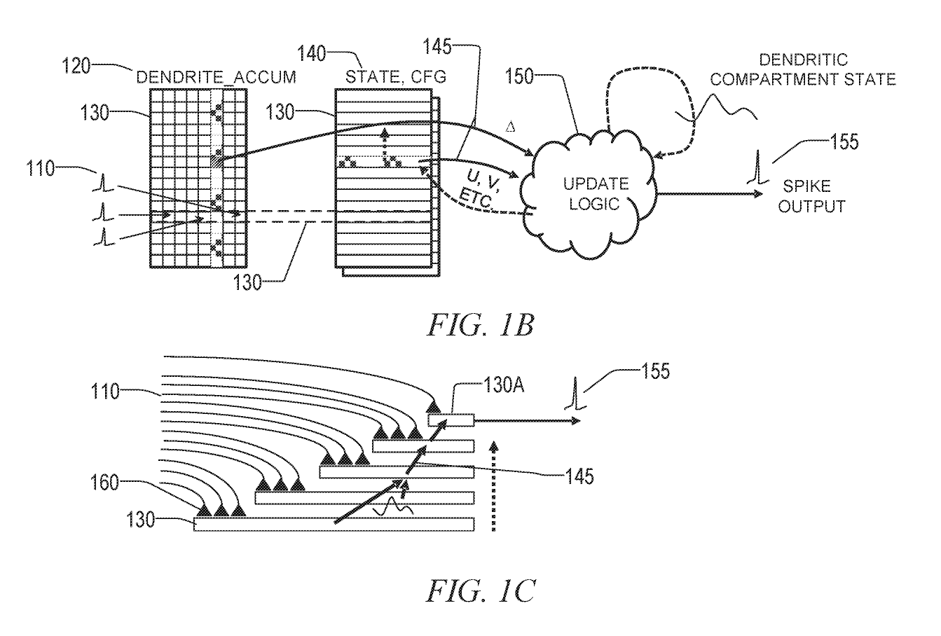

FIG. 1A is a high-level block diagram of a model neural core structure 10 that loosely models a biological neural structure. An action potential, or spike, signal is provided at an input 20 to the synapse 30 (this is actually a fan-out within the core to other dendrite structures with appropriate weight and delay offsets) and, after processing, is provided to a dendrite structure 40 comprising a dendrite accumulator 42 and a soma state store 44. When the soma enters a sufficiently activated state, it may produce new spikes that the dendrite structure 40 outputs to an axon (Y50) (this is actually a fan-out of the spike within the core to other destination cores) for subsequent output 90. Not shown is a routing network of some form that distributes the spikes, in the form of individually addressed data packets, to the appropriate destination cores in a larger system. The outputs core or set of cores will commonly include the core that produced each spike.

The system also permits backwards processing. In biology, when the soma spikes, in addition to that spike propagating downstream to the output neurons, the spike also propagates backwards down through a dendritic tree, which is beneficial for learning. The synaptic plasticity at the synapses is a function of when the postsynaptic neuron fires and when the presynaptic neuron fires. Each synapse self-adjusts its parameters based on the correlations in activity between its input and output neurons, as indicated by their spike times. In a multi compartment architecture, once the soma fires, there are other elements that need to know that the neuron fired in order to support learning, so all of the input fan-in synapses 30 see that the neuron fired. The spike timing dependent plasticity (STDP) module 80 may receive this backwards action potential (bAP) notification 70 and communicate with the synapses 30 accordingly.

Each component of the neural core described above, corresponding loosely to analogous functions in a biological neuron, may be replicated for a potentially large number of these elements contained within the core. The logical processing of these state elements within the core may occur in a sequential, time-multiplexed manner, as is used in typical high-performance digital circuits.

The present disclosure focuses on multi-component dendrites and dendritic compartments within the dendrite model 40, which is expanded upon below.

FIG. 1B is a pictorial diagram that illustrates one configuration of a multi-compartment neurons and a dendritic accumulation process for handling, and scheduling spikes into the future handling, inside the core. Synaptic inputs 110 are provided to a dendrite accumulator structure 120, which may architecturally be a matrix that maintains synaptic stimulation counters of weight values for a particular compartment 130. A compartment 130, as defined herein, is a conceptual neural unit that contains state and configuration variables 140 for the dynamic state of a neuron. It is a component of a dendritic tree that may be processed in sequence with related compartments. Preserving some state information for a compartment 130 and passing it along as the compartments are processed provides for a broad class of information processing that may happen in the core.

The processing of compartments 130 may be limited if the state information is not preserved and passed on in subsequent processing. A simple spiking neuron model may invoke both excitatory input and inhibitory input, and the two input classes have two different time constants typically, which may control the filtering that is applied to the time domain inputs. To implement the simple spiking neuron model in the most straightforward way would mean building that capability into every single compartment 130, which makes the logic more complex and the state more costly. With the multi-compartment system, the processing may be broken down into two compartments, with the results from each later added together to get the ultimate current stimulation for a neuron. This more complex neuron type may be supported without needing to implement the more complex functionality as the common denominator across all compartments in the core. That functionality that may not be necessary for many algorithmic applications, so the more flexible multi-compartment structure provides efficiency gains for those simpler applications.

A dendrite accumulator structure 120 may maintain synaptic stimulation counters of weight values for a particular compartment 130, the compartment being a breakdown of a neural tree structure or simply an abstract neural unit. Each compartment 130 may have state variables (u, v) that contain a dynamic state of what is occurring in the neuron.

A sequential process with the update logic 150 may walk through all of these compartments 130 (compartment indices), and receive configuration parameters and state variables 145 from each of the compartments 130. As a result of the update, the compartment may generate a spike output 155. Because this is a sequential process, it is inexpensive and easy to preserve some state information that is associated with propagating information of the tree while the update logic 150 loops over the compartment indices. This can be accomplished simply by utilizing temporary register storage in the logic.

FIG. 1C is a pictorial diagram that shows a state structure of multiple compartments and illustrates how the sequential walk through the compartment indices 130 can easily implement a tree-like data flow. Each of the rows 130 of this state structure, which may be memory elements in the core's SRAMs, represents a compartment 130 that receives synaptic input 110, via synaptic connections 160. The core walks through these with state variables 145 being propagated from each of the compartments 130, up to one final route compartment 130A which would be the soma (in the biological nomenclature), which provides a spike output 155. All of the other compartments 130 in FIG. 1C are simply passing on their intermediate terms. Any dendrite index may be configured as either a compartment in the dendritic tree or a soma. The tree structure may be implemented by propagating and combining real-valued current and/or voltage states iteratively, for example, in some fixed-point digital encoding, as described below.

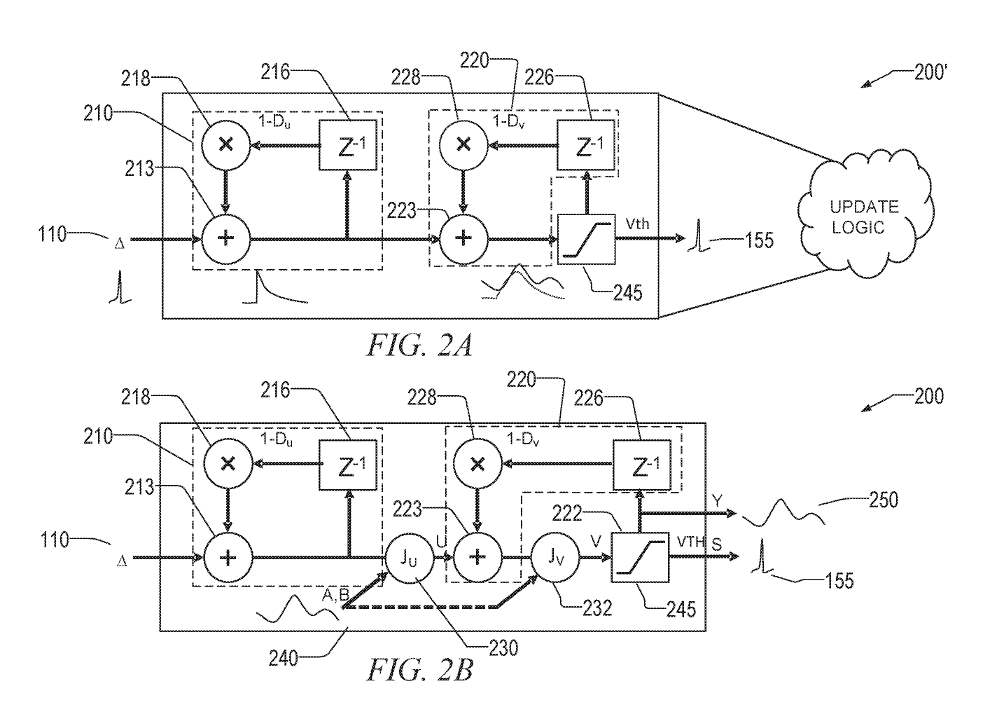

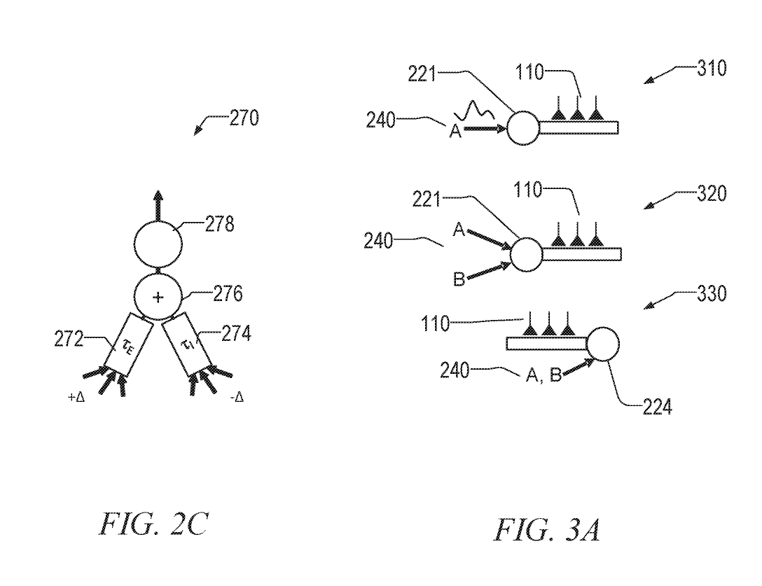

FIG. 2A is a block diagram illustrating state dynamics for a dendritic compartment 200′ (use of the term “dendrite” below is to be construed synonymous with, and as shorthand for, the phrase “dendritic compartment”) according to a simple neuron model, which is basically a discrete time filtering circuit. A first state variable operation 210 may be performed that is based on a stored first state variable, in this example, the current u, and the spike input 110 received. A second state variable operation 220 may then subsequently performed that is based on a stored second state variable, in this example, the voltage v, and the output of the first variable operation 210. A threshold function 245 may be utilized to determine if the dendritic compartment 200′ should spike or at least indicate a spiking value even if it does not actually spike.

The compartment signal processing model shown in FIG. 2A represents one possible embodiment that implements a simple current-based Leaky Integrate-and-Fire (LIF) neuron model. The subthreshold dynamics of the LIF neuron model are described by the following discrete-time dimensionless difference equations, as provided by filters 210 and 220 respectively:

$$u [ t ] = ( 1 - \frac{1}{{τ}_{s}} ) u [ t - 1 ] + {\sum }_{i ∈ l} {w}_{i} {s}_{i} [ t ]$$

$$v [ t ] = ( 1 - \frac{1}{{τ}_{m}} ) v [ t - 1 ] + u [ t ] + b$$

where:

τₛ and τₘ are synaptic and membrane time constants, respectively;

I is the set of fanin synapses for the neuron;

wᵢ is the weight of synapse i;

sᵢ[t] is the count of spikes received for time step t at synapse i, after accounting for synaptic delays;

b is a constant bias current; and

Δ=Σ_{i∈I}wᵢsᵢ[t] corresponds to dendrite accumulator input 110.

For computational efficiency, the exponential scalings are configured and scaled according to the following fixed-point approximation:

$$( 1 - \frac{1}{τ} ) \approx \frac{4096 - D}{4096}$$

where the D decay constants (Dᵤ and Dᵥ in FIG. 2A) can range over [0,4096], corresponding to τ time constants nonlinearly spaced over the range [1,∞].

When the membrane voltage v[t] passes some fixed threshold Vth from below, the compartment generates an output spike 155.

FIG. 2B is a block diagram illustrating state dynamics and the dendritic accumulation process for a dendritic compartment 200 according to a multi-compartment neuron model. The dendritic compartments 200, 200′ may be, for example, the dendritic compartments 130 described above. The diagram of FIG. 2B is similar to the diagram in FIG. 2A, and a description of similar elements will not be repeated. However, in the design shown in FIG. 2B, to enhance the design for the multi-compartment processing, two points J_{U} 230, J_{V} 232, have been added in the logic where information coming from earlier compartments A, B 240 in the sequential process may be joined.

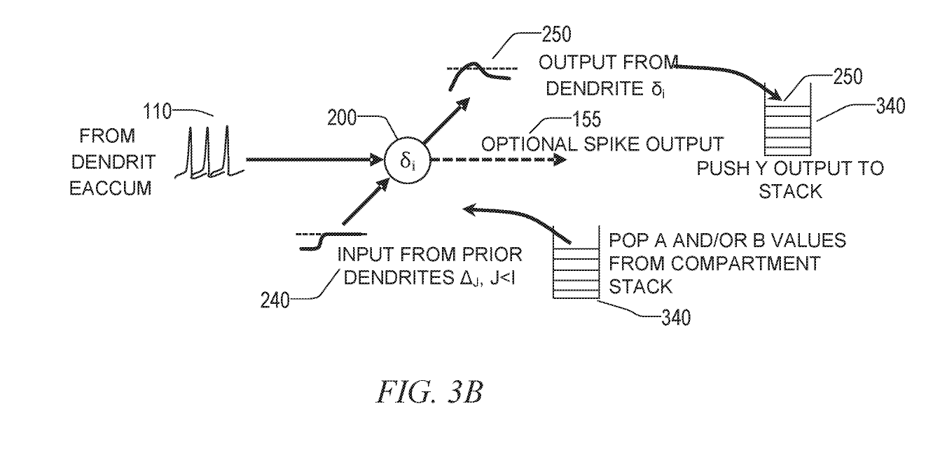

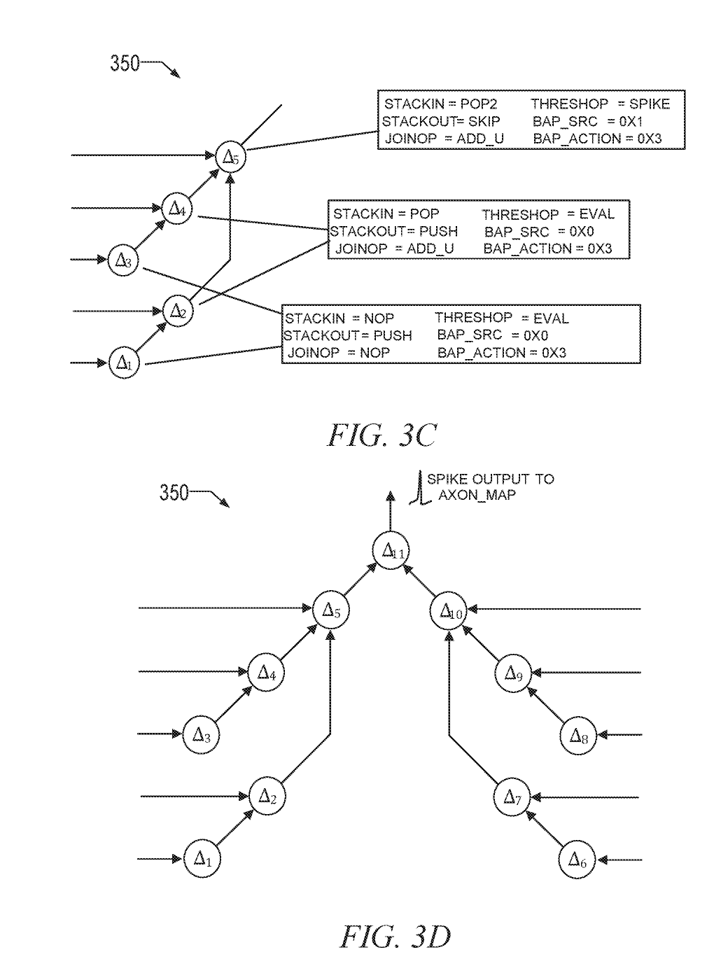

The structure described above provides a way to join in, as in a tree structure, the earlier input A, B 240 on towards the root of a dendritic tree (FIG. 3D, discussed in more detail below). Each of these join operations J_{U} 230, J_{V} 232, combines a dynamic state variable, either u (current) or v (voltage), from one or more input compartments that are thereby interlinked to the destination compartment. Since there are two such variables in this example, there are two different join possibilities (join points in the signal flow) 230, 232.

The current from the earlier input 240 may be provided at a first junction point 230, and the voltage from the earlier input 240 may be provided at a second junction point 232. When so configured, a compartment may produce an output value Y 250 corresponding to one or more fixed-point numbers representing state variables u or v of the dendritic compartment 200. The Y output thereby becomes the input to join operations 230 or 232 of downstream compartments. Additionally, a spike function 222 may be configured to send a spike value S 155 (a binary value representative of a spike) if the compartment's spike threshold value has been reached, which may also be referenced as an input in downstream join operations.

A common application, as illustrated, is a neuron that may be stimulated with both excitatory and inhibitory input, each with its own exponential filtering time constant. This spiking neuron model and networks of these neurons may be capable of implementing powerful neural information processing algorithms (e.g., E/I networks).

FIG. 2C is a block diagram that illustrates an example of an E/I neuron 270. With the multi-compartment support described herein, an E/I neuron may be constructed out of two primitive units (compartments), a first 272 that integrates the “E” input that decays exponentially with the τ_{E} time constant, and a second 274 that integrates the “I” input that decays exponentially with τ_{I} time constant. The “E” input is excitatory synaptic input and the “I” input is inhibitory synaptic input. An ADD_U JoinOp 276 is illustrated as an example in which currents from the E compartment 272 and the I compartment 274 are linearly added. An output compartment 278 is configured as the soma—it produces a spike output when the total activation from its input compartments (increased by E and reduced by I) is sufficiently high.

An alternative is to implement a more complex single neuron model that includes the complexity of the E/I neuron implementation. Since many neuromorphic algorithms may not need this complexity, the presently described architecture provides a flexible and efficient neuromorphic processing solution. In this manner, the architecture can be generalized to an extremely flexible neuromorphic processor that can, through programming, implement a wide range of conventional neuron models (some with potentially significant value for machine learning applications).

In biology, an efficiency may be realized by communicating numbers 250 (continuous data) as opposed to just binary spike values 155. The generation of neural networks that is focused on spiked base signaling is largely driven by the efficiency that comes from long-range parallel communication using just a bare minimum of information for energy and performance efficiency. Although it is possible to process a large space of algorithmic problems with basic spike base signaling methodology, this approach is limited. There is still value in communicating numbers 250 as opposed to just binary spike events 155 with temporal codes, specifically when the communication is sufficiently local. Biological neurons use their dendritic trees for this purpose. A dendritic tree may be viewed as a spatially local region of the neuron over which it is efficient to send continuous current or voltage values across the membrane of the neuron. This principle also applies to neuromorphic computations embodied in silicon VLSI circuits.

FIG. 3A is a pictorial diagram of some structural models that this architecture may support. A series of join operations may be provided that constitutes a manner of an instruction set that the core supports. For example, one might add the u variable along with an input from another compartment. Or, instead of an add, a multiply may be used as the join operation. Also possibly included is, for example, an AND of a spiking condition of whether the input compartment is past its threshold or not, and then whether this compartment's v has passed its threshold or not—the AND condition of those two, or the OR condition of those two could also be taken. There are a number of different operations that may be defined (see Table 1 below).

The structure that includes information from other compartments gives the dendritic tree structure a large amount of computational capability, compared to a pure feed-forward calculator. This creates a very flexible interlinked dynamic system of these differential equation state variables.

With regard to the structural models for a dendritic compartment, in a first structure 310, a single input A from earlier compartment information 240 is provided into a join operation 230 to which synaptic inputs 110 are applied post-operation. The single input structure provides for linear chaining, successive attenuation/scaling, and Boolean gating conditions. In a second structure 320, similar to the first structure 310, two inputs A, B from earlier compartment information 240 are provided into the join operation 230. This structure may be used for “current mode” joining, and permits local synapses to gate downstream branches. In a third structure 330, the synaptic inputs 110 are applied pre-operation, and the join operation 230, 232 includes the synaptic inputs along with the two inputs A, B, from earlier compartment information 240. This structure may be used for “voltage mode joining”, involving multiplicative non-linearity, and Boolean spike conditions (AND/OR).

A set of operations may be provided, described in more detail in Table 1 below, that may be viewed as an instruction set of what the core supports. For example, one could add from the u variable and provide input from the other compartment 240. One could multiply, take an AND of a spiking condition of whether the input compartment is past its threshold or not, and then whether the destination compartment has passed its threshold or not. One could also take an OR of those two, or use any number of different defined join operations. This approach endows the dendritic tree structure with a large amount of computational capability. Furthermore, the recurrent connections often present in the larger network, along with the inherent temporal dimension of spiking neural networks, serve to dynamically interlink these state variables as a system of nonlinear integral equations, giving the system computational capabilities far beyond those of a simple feed forward calculator.

FIG. 3B is a pictorial diagram illustrating the inputs and outputs of a dendritic compartment 200. The inputs 110 are provided to the dendritic compartment δᵢ 200, along with the inputs from prior dendrites δⱼ (j<i) 240. In addition to a possible spike output 155, a continuous output 250 is also provided.

As can be seen in FIG. 3B, one approach to implementing this is to use a stack 340 along with stack semantics. Stacks can be efficiently implemented with electronic circuits, and stack semantics can be easily encoded with a small number of compartment configuration bits. As shown in FIG. 3B, the output 250 from the dendrite & is pushed onto a stack 340, and the input from the prior dendrite j is popped from the stack 340.

With as few as three primitive operations per compartment, namely PUSH, POP, and POP2 (pop two elements from the stack), arbitrary tree structures may be constructed. The system may utilize these stack semantics to simplify the encoding and implementation of each compartment's behavior as it relates to compartment-to-compartment communication.

FIGS. 3C and 3D, which are pictorial diagrams of dendritic trees, provide specific examples of how primitive stack operations (e.g., PUSH, POP, POP2) may be used to construct arbitrary trees 350 of neural units that are individually updated sequentially in a natural manner for silicon circuit implementation.

Each compartment 200 may support a variety of “operations” 230, 232 that control how the information from the stack 340 may be integrated into the neural unit's processing model. These may include, for example, ADD, MUL, PASS, BLOCK, AND, OR, etc. Table 1, below, provides some further example operations that may be supported.

TABLE 1
Example Operations

| Field | Bits | Description | Encoding | |
|---|---|---|---|---|
| Stackln | 15:14 | Compartment stack | 0: (SKIP) | Don't read from the CStack |
| | | input handling | 1: (PEEK) | Peek from the CStack |
| | | | 2: (POP) | Pop from the CStack |
| | | | 3: (POP2) | Pop two from the CStack |
| StackOut | 13:12 | Compartment stack | 0: (SKIP) | Don't push to the CStack |
| | | output handling | 1: (PUSH) | Push (Y, S) to the CStack |
| | | | 2: (PUSHN) | Push (normalize(Y), S) to the |
| | | | | CStack |
| JoinOp | 11:8 | Compartment join | 0: (NOP) | |
| | | operation | 1: (ADD_U) | U′ = U + A + B |
| | | | 2: (MAX_U) | U′ = max(U, A, B) |
| | | | 3: (MIN_U) | U′ = min(U, A, B) |
| | | | 4:(PASS_U) | U′ = A.S ? U + B : 0 |
| | | | 5: (BLOCK_U) | U′ = A.S ? 0 : U + B |
| | | | 6: (OR_S) | S′= A.S \| B.S \| S |
| | | | 7: (AND_S) | S′ = A.S \| B.S* & S |
| | | | 8: (MUL_V) | U′ = U + B; V′ = V*A/2²³ |

| | | | |
|---|---|---|---|
| ThreshOp | 7:6 | Operation to apply | 0: Spike |
| | | when V > Vth | 1: Spike w/random RefractDelay |
| | | | 2: Evaluate S = V > Vth only |
| | | | 3: Evaluate: S = V > Vth and saturate at Vth |
| bAP_Src | 5:2 | Mask over potential bAP | 0: Activate bAP when V > Vth |
| | | sources | 1: unused |
| | | | 2: Activate bAP when S = 1 from cx input 0 |
| | | | 3: Activate bAP when S = 1 from cx input 1 |
| hAP_Action | 1:0 | Action to apply when | Bit 0: Activate refractory state |
| | | bAP occurs | Bit 1: Propagate bAP backwards |

*B.S = 1 if not valid (e.g., when JoinOp==POP, not POP2

The dendritic compartment 200 may thus receive and send information on a dendritic compartment chain through the stack 340, where, when it requires data from the compartment bus or the stack, it pops it, and if it is going to send data, it pushes it. These correspond to the primitive operations using just the push the POP and the POP2.

Described in more detail, FIG. 3C illustrates tree structures that may be built out using these operations in which the dendrite identifiers (deltas) are numbered (subscript) as they would be sequentially serviced by the core, it starts at δ₁ and ends at δ₅. The first dendrite compartment δ₁ PUSHes, and the second dendrite compartment δ₂ POPs and PUSHes, the third dendrite compartment δ₃ just PUSHes (it is not going to consume what the second dendrite compartment δ₂ produces), the fourth dendrite compartment δ₃ POPs and PUSHes, and the fifth dendrite compartment δ₅ performs a POP2. If the fifth dendrite compartment δ₅ is configured as a soma, and if the conditions are right this would be the compartment that spikes. FIG. 3D is a pictorial diagram showing a larger example with ten dendrites receiving synaptic input, aggregated in order of their δᵢ subscripts, and a final dendrite δ₁₁ configured as the aggregate neuron's soma that produces its spike outputs.

Thus, this construction makes the neural processor more closely analogous to a normal processor—it is a programmable structure (in a sense), where each compartment, through programming, may be controlled to function in a particular manner, through its input stack operation, its output stack operation, join operation(s), the threshold operation (whether to spike when a threshold is exceeded, or even whether the threshold is simply evaluated but does not change the neuron state, as a spike would (e.g., when conveying the state of whether the threshold has been exceeded or not)). These functions may all be programmed in the form of compartment configuration parameters, and this may be considered part of the programming of the core. This “programming” allows the core to execute a wide range of different neuromorphic algorithms that depend on multi-compartment dendritic processing interactions.

In biology, when the soma spikes, the spikes often propagate backwards, or towards the leaves, through the dendritic tree, and this mechanism is beneficial for learning. The plasticity at the synapses is a function of when and how often the postsynaptic neuron fires as well as when and how often the presynaptic neuron fires, so the synapse needs to be informed of the timing of these events. This may be part of a spike timing dependent plasticity (STDP) model, which may implement Hebbian learning, anti-Hebbian learning, and other models.

This poses a challenge for a multi-compartment neuromorphic core architecture since whenever the soma compartment fires, in order to support learning, all input compartments to the soma will need to be informed that the neuron fired so that the entire set of input fan-in synapses can respond appropriately. Yet in an efficient core design involving time-multiplexing and pipelining, the servicing of those input compartments will have occurred in the past and the pipeline will be busy servicing subsequent compartments beyond the soma.

In terms of programming, the backwards spike propagation may be implemented without requiring any further configuration of the core simply by executing the stack operations already configured in reverse order. However, for the sake of efficiency, it is undesirable for the backwards propagation be continuously active. A backwards spike propagation may be considered analogous to an exception in normal processor technology. The pipeline must be flushed, and the processing may need to go back to some known point. Here, the process will identify a spiking compartment as it iterates through the compartments, at which point the core may need to flush or stall the pipeline and then perform a backwards traversal/propagation.

Fortunately, for the sake of efficiency, this is an infrequent event, since neurons do not spike all the time—they only spike on an event when the spiking threshold has been exceeded. The backwards propagation may be provided, but it comes as a hit in the performance, because the processor has already progressed along to later compartments. The system waits for the processing to complete, and then insert the backwards propagation through the tree. A few bits of configuration may be used to prune that operation and specify each compartment's behavior in the backwards pass. An example of this configuration is shown in Table 1 (bAP_Src and bAP_Action fields). In terms of the example of FIG. 3D, when the soma of the dendritic compartment ti spikes, the system waits for the pipeline to clear, and then it inserts a backwards pass. It goes backwards through the tree, and the learning takes place at the leaves.

As described above, threshold information may be passed without actually spiking. A Boolean state variable may be propagated through the compartment stack which represents whether the voltage has exceeded the threshold or not, but this does not have to produce a spike for all of the intermediary compartments in a neuron tree. These would normally not be producing spikes but instead produce a Boolean S value, which is the spiking “state”. At a particular join point, the system supports generating a backwards action potential (bAP). Based on the example definition of the bAP_Src configuration in Table 1, a compartment may generate a bAP event in response to its own V>Vth threshold evaluation (its S=1 state), whether or not it is configured to generate an outbound spike, or when an input compartment's S state equals 1 (from a lateral branch). The latter option allows a backwards propagating spike to be generated in response to activation in an unrelated branch of the tree, without necessarily causing the neuron as a whole to spike.

With the semantics of the bAP_Src and bAP_Action parameters defined in Table 1, spikes may generate bAP waves spanning all of the neuron's compartment tree or over a more limited sub-tree. In some cases, the bAP event may involve just one leaf compartment. This bAP activity can operate at a small cost in core energy consumption by not causing the soma compartment to actually spike, saving all downstream spike routing and weight accumulation costs. This can be advantageous for some learning models by allowing neurons and neural parameters to adapt to sub-threshold patterns of activation.

Specifically, from the perspective of dendritic plasticity, the parameters associated with the neuron model itself, such as its threshold, time constants, bias currents, synaptic scaling constants, or JoinOp input scaling constants, may be dynamic and may change in response to either bAP spikes or forward going spikes. Based on the activation of a particular compartment 200, some of the parameters of this computational neuron model may be modified and be responsive to activity through the tree 350 of dendritic compartments. That is to say, the compartment parameters themselves may also change in response to the bAP mechanism. In terms of hardware implementation cost, such features may be readily and efficiently implemented due to the locally scoped and event-driven nature of the bAP mechanism.

In the dendritic tree 350, in this neuromorphic core implementation, local information (Y and S as defined above) can be communicated across the full extend of a multi-compartment dendritic tree with constant hardware resource cost, independent of the size of the tree or the number of compartments implemented by the core. This is because the core, for efficiency and performance reasons as explained above, already must sequentially service the compartment state sequentially in a time-multiplexed way. The sequential process illustrated in FIGS. 3C and 3D walks through all of the compartment indices in a logic loop, which makes it very cheap and easy to just preserve, in a temporary storage register (e.g., latches, flip-flops, or SRAM state bits in the core), some state information that is associated with propagating information of the tree. As the logic walks through the compartment indices, it is possible to propagate numbers (the state variables) from each of the compartments, up to one final route compartment (a soma in the biological nomenclature) which is the one that spikes (in FIG. 3D, this is δ₁₁). All of the other compartments may just pass on their intermediate state terms. At the final route compartment, the temporary storage register is guaranteed to be empty and available for the next multi-compartment neuron's use.

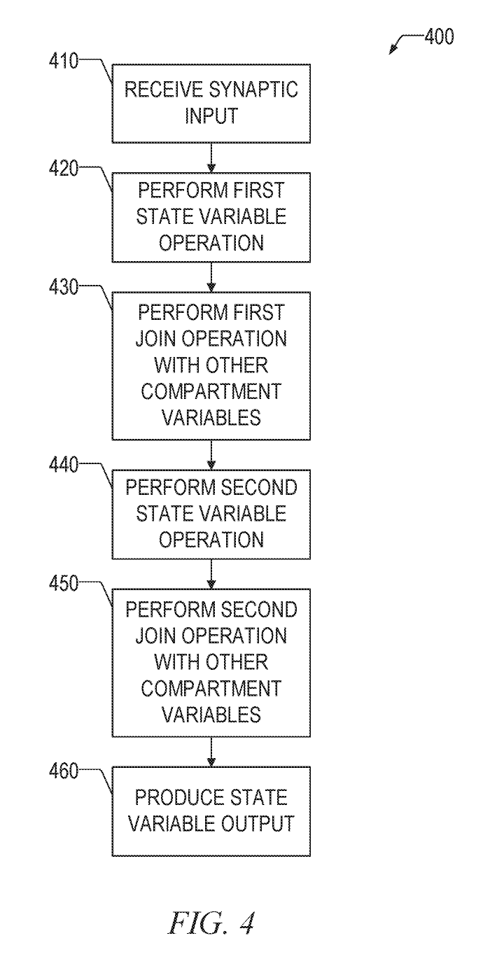

FIG. 4 is a flowchart of an example use of dendritic compartments, as described above. In operation 410, a synaptic input to the dendritic compartment is received by the core. In operation 420, the core performs a first state variable operation. In operation 430, a first join operation is performed using one or more output variables of another compartment that is lower in a dendritic hierarchical tree structure with a lower compartment index and therefore was serviced earlier. In operation 440, the core performs a second state variable operation. In operation 450, a second join operation is performed using one or more output variables of the same input compartment or compartments. Finally, in operation 460, a state variable output is provided—optionally, a spike may be provided as well.

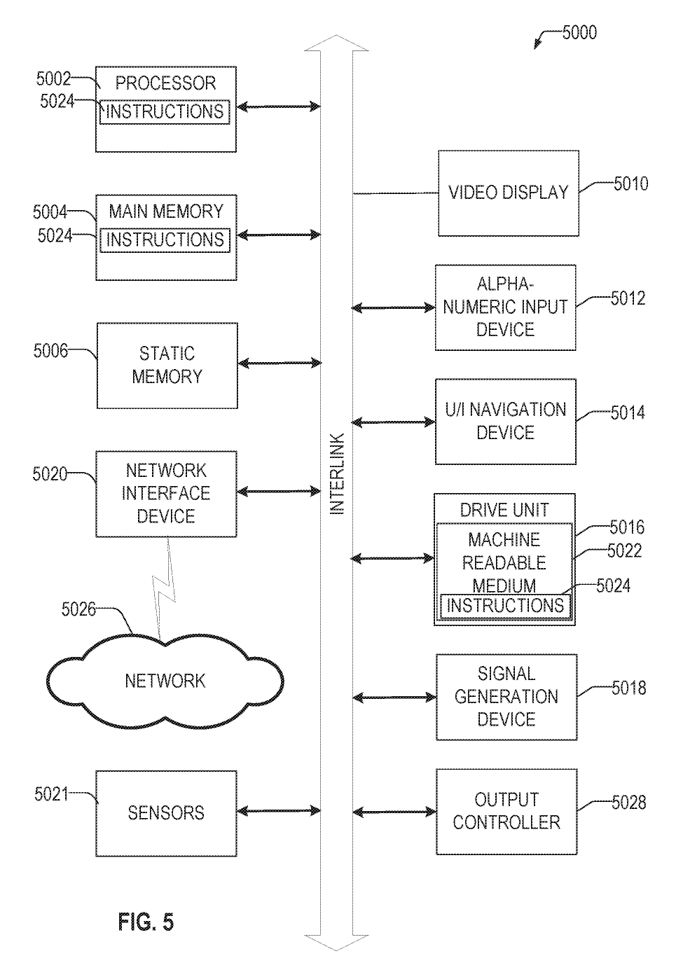

FIG. 5 is a block diagram illustrating an example of a machine 5000 upon which one or more of the techniques (e.g., methodologies) discussed herein may be performed. In alternative embodiments, the machine 5000 may operate as a standalone device or may be connected (e.g., networked) to other machines. In a networked deployment, the machine 5000 may operate in the capacity of a server machine, a client machine, or both in server-client network environments. In an example of a machine described herein, the machine 5000 may act as a peer machine in peer-to-peer (P2P) (or other distributed) network environment. The machine 5000 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Machine 5000 may function as an MUA, MTA, computing device executing an application, DNS, CA, PKS, Key Manager, Key Keeper, or the like. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules may include tangible entities (e.g., hardware) capable of performing specified operations and may be configured or arranged in a certain manner. In an example, circuits may be arranged (e.g., internally or with respect to external entities such as other circuits) in a specified manner as a module. In an example as described herein, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example as described herein, the software, when executed by the underlying hardware of the module, causes the hardware to perform the specified operations.

Accordingly, the term “module” is understood to encompass a tangible entity, and that entity may be one that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 5000 may include a neuromorphic processor 110, 300, a hardware processor 5002 (e.g., a central processing unit (CPU), a graphics processing unit (GPU), a hardware processor core, or any combination thereof), a main memory 5004 and a static memory 5006, some or all of which may communicate with each other via an interlink (e.g., bus) 5008. The machine 5000 may further include a display unit 5010, an alphanumeric input device 5012 (e.g., a keyboard), and a user interface (UI) navigation device 5014 (e.g., a mouse). In an example described herein, the display unit 5010, input device 5012 and UI navigation device 5014 may be a touch screen display. The machine 5000 may additionally include a storage device (e.g., drive unit) 5016, a signal generation device 5018 (e.g., a speaker), a network interface device 5020, and one or more sensors 5021, such as a global positioning system (GPS) sensor, compass, accelerometer, or other sensor. The machine 5000 may include an output controller 5028, such as a serial (e.g., universal serial bus (USB)), parallel, or other wired or wireless (e.g., infrared (IR), near field communication (NFC), etc.) controller connection to communicate or control one or more peripheral devices (e.g., a printer, card reader, etc.).

The storage device 5016 may include a machine readable medium 5022 on which is stored one or more sets of data structures or instructions 5024 (e.g., software) embodying or utilized by any one or more of the techniques or functions described herein. The instructions 5024 may also reside, completely or at least partially, within the main memory 5004, within static memory 5006, or within the hardware processor 5002 during execution thereof by the machine 5000. In an example, one or any combination of the hardware processor 5002, the main memory 5004, the static memory 5006, or the storage device 5016 may constitute machine readable media.

While the machine readable medium 5022 is illustrated as a single medium, the term “machine readable medium” may include a single medium or multiple media (e.g., a centralized or distributed database, and/or associated caches and servers) configured to store the one or more instructions 5024.

The term “machine readable medium” may include any medium that is capable of storing, encoding, or carrying instructions for execution by the machine 5000 and that cause the machine 5000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 5024 may further be transmitted or received over a communications network 5026 using a transmission medium via the network interface device 5020. The Machine 5000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 5020 may include one or more physical jacks (e.g., Ethernet, coaxial, or phone jacks) or one or more antennas to connect to the communications network 5026. In an example, the network interface device 5020 may include a plurality of antennas to wirelessly communicate using at least one of single-input multiple-output (SIMO), multiple-input multiple-output (MIMO), or multiple-input single-output (MISO) techniques. In some examples, the network interface device 5020 may wirelessly communicate using Multiple User MIMO techniques.

Functions, operations, components and/or features described herein with reference to one or more embodiments, may be combined with, or may be utilized in combination with, one or more other functions, operations, components and/or features described herein with reference to one or more other embodiments, or vice versa.

For the purposes of promoting an understanding of the principles of this disclosure, reference has been made to the various configurations illustrated in the drawings, and specific language has been used to describe these configurations. However, no limitation of the scope of the inventive subject matter is intended by this specific language, and the inventive subject matter should be construed to encompass all embodiments and configurations that would normally occur to one of ordinary skill in the art. The configurations herein may be described in terms of functional block components and various processing steps. Such functional blocks may be realized by any number of components that perform the specified functions. The particular implementations shown and described herein are illustrative examples and are not intended to otherwise limit the scope of the inventive subject matter in any way. The connecting lines, or connectors shown in the various figures presented may, in some instances, be intended to represent example functional relationships and/or physical or logical couplings between the various elements. However, many alternative or additional functional relationships, physical connections or logical connections may be present in a practical device. Moreover, no item or component is essential unless the element is specifically described as “essential” or “critical”. Numerous modifications and adaptations will be readily apparent to those skilled in this art.

### EXAMPLES

Example 1 is an electronic neural core circuit, comprising: a plurality of neural compartments that are collectively serviced over time to evolve respective compartment states, wherein each servicing corresponds to a neuromorphic time step, and each compartment comprises a state variable representing a state of the neural compartment; wherein the neural core circuit is configured to perform operations to, for a neural compartment during the neuromorphic time step: a) receive a synaptic input; b) perform a state variable operation utilizing: 1) a stored state variable that was stored in the neural compartment prior to receipt of the synaptic input, and 2) the synaptic input, thereby producing a state variable result; c) perform a join operation utilizing: 1) the state variable result, 2) input from a state variable from an other compartment that has been previously processed, and 3) a join operation configuration that is stored in or associated with the neural compartment, thereby producing a join operation result; and d) produce a state variable output based on the join operation.

In Example 2, the subject matter of Example 1 optionally includes wherein the neural core circuit is further configured to produce a spike-related output if the join operation result reaches a spiking threshold.

In Example 3, the subject matter of Example 2 optionally includes wherein the spike-related output is an actual spike event.

In Example 4, the subject matter of any one or more of Examples 2-3 optionally include wherein the spike-related output is a spiking state value only, that is a part of the state variable output.

In Example 5, the subject matter of any one or more of Examples 1-4 optionally include wherein: the neural core circuit is further configured to utilize a stack; and the join operations include stack operations to communicate state variables from one dendritic compartment to a different dendritic compartment.

In Example 6, the subject matter of Example 5 optionally includes wherein: the stack operations include push and pop; and the neural core circuit is further configured to pop input from the state variables from the other compartment from the stack, and to push the state variable output to the stack.

In Example 7, the subject matter of any one or more of Examples 1-6 optionally include wherein the operations include stack operations, the join operations, threshold operations, backward action potential (bAP) operations, mathematical operations, and Boolean logic operations.

In Example 8, the subject matter of any one or more of Examples 1-7 optionally include wherein the neural core circuit is further configured to, upon completion of operation (d) for a first neural compartment, perform operations (a)-(d) for a second neural compartment, wherein at least one variable output of the first neural compartment is at least one of the variables from the other compartment in the second neural compartment.

In Example 9, the subject matter of Example 8 optionally includes wherein the neural core circuit is further configured to execute through a hierarchical dendritic tree structure from the dendritic compartments it processes and produce a spiking event from only a highest dendritic compartment of the dendritic tree structure.

In Example 10, the subject matter of Example 9 optionally includes wherein the neural core circuit is further configured to generate a backward action potential (bAP) that executes through the hierarchical dendritic tree structure in a reverse order, based on the spiking event.

In Example 11, the subject matter of Example 10 optionally includes wherein the neural core circuit is further configured to communicate the bAP, including its implicit spike time or spike time dependent state variable, to all fan-in synapses of all dendritic compartments that receive synaptic input.

In Example 12, the subject matter of any one or more of Examples 10-11 optionally include wherein the neural core circuit is further configured to change one or more parameters associated with a neuron model of a dendritic compartment itself in response to a backward action potential (bAP) or forward going spikes or spiking state values.

In Example 13, the subject matter of Example 12 optionally includes wherein one of the parameters is a spiking threshold.

In Example 14, the subject matter of Example 13 optionally includes wherein the one or more parameters include at least the spiking threshold, state variable exponential decay time constants, current bias constants, scaling constants applied to synaptic inputs, and scaling constants applied to join operation inputs.

In Example 15, the subject matter of any one or more of Examples 8-14 optionally include wherein the neural core circuit is further configured to concurrently process a plurality of dendritic compartments.

In Example 16, the subject matter of any one or more of Examples 1-15 optionally include wherein: the state variable is a first state variable; the neural compartment comprises a second state variable representing a second state of the neural compartment; the neural core circuit is further configured to perform operations to, for a neural compartment during the neuromorphic time step: e) perform a second state variable operation utilizing: 1) a stored second state variable that was stored in the memory prior to receipt of the synaptic input, and 2) the first join operation, thereby producing a second state variable result; and f) perform a second join operation utilizing: 1) the second state variable result, 2) input from a second state variable from the other compartment that has been previously processed, and 3) join operation configuration that is stored in the memory associated with the neural compartment, thereby producing a second join operation result; and wherein the producing of the state variable output is further based on the second join operation.

Example 17 is a method executed by a processor of an electronic neural core circuit, comprising: during a neuromorphic time step: a) receiving a synaptic input at a dendritic compartment; b) performing a state variable operation utilizing: 1) a stored state variable that was stored in the memory prior to receipt of the synaptic input, and 2) the synaptic input, thereby producing a state variable result; c) performing a join operation utilizing: 1) the first state variable result, 2) input from a first state variable from an other compartment that has been previously processed, and 3) join operation configuration that is stored in the memory associated with the neural compartment, thereby producing a first join operation result; and d) producing a state variable output based on the join operation.

In Example 18, the subject matter of Example 17 optionally includes operating using a stack, and communicating state variables from one dendritic compartment to a different dendritic compartment using stack operations in the join operations.

In Example 19, the subject matter of Example 18 optionally includes popping input from the state variables from the other compartment from the stack, and pushing the state variable output to the stack.

In Example 20, the subject matter of any one or more of Examples 17-19 optionally include wherein the operations include stack operations, the join operations, threshold operations, backward action potential (bAP) operations, mathematical operations, and Boolean logic operations.

In Example 21, the subject matter of any one or more of Examples 17-20 optionally include executing through a hierarchical dendritic tree structure from the dendritic compartments being processed; and producing a spiking event from only the highest level value.

Example 22 is a system comprising means to perform any of the methods of Examples 17-21.

Example 23 is at least one machine readable medium including instructions that, when executed by a machine, cause the machine to perform any of the methods of Examples 17-21.

Example 24 is at least one machine-readable storage medium, comprising a plurality of instructions adapted for execution within an electronic neural core circuit, wherein the instructions, responsive to being executed with the neural core circuit of a computing machine, cause the computing machine to perform operations that: during a neuromorphic time step: a) receive a synaptic input at a dendritic compartment; b) perform a state variable operation utilizing: 1) a stored state variable that was stored in the memory prior to receipt of the synaptic input, and 2) the synaptic input, thereby producing a state variable result; c) perform a join operation utilizing: 1) the first state variable result, 2) input from a first state variable from an other compartment that has been previously processed, and 3) join operation configuration that is stored in the memory associated with the neural compartment, thereby producing a first join operation result; and d) produce a state variable output based on the join operation.

In Example 25, the subject matter of Example 24 optionally includes wherein the instructions are further operable to configure the circuit to utilize a stack and the join operations include stack operations to communicate state variables from one dendritic compartment to a different dendritic compartment, wherein the stack operations include push and pop, and the processor is further configured to pop input from the state variables from the other compartment from the stack, and to push the state variable output to the stack.

Example 26 is a system of operating an electronic neuromorphic core processor, comprising, during a neuromorphic time step: a) means for receiving a synaptic input at a dendritic compartment; b) means for performing a state variable operation utilizing: 1) a stored state variable that was stored in the memory prior to receipt of the synaptic input, and 2) the synaptic input, thereby producing a state variable result; c) means for performing a join operation utilizing: 1) the first state variable result, 2) input from a first state variable from an other compartment that has been previously processed, and 3) join operation configuration that is stored in the memory associated with the neural compartment, thereby producing a first join operation result; and d) means for producing a state variable output based on the join operation.

In Example 27, the subject matter of Example 26 optionally includes means for operating using a stack, and communicating state variables from one dendritic compartment to a different dendritic compartment using stack operations in the join operations.

In Example 28, the subject matter of Example 27 optionally includes means for popping input from the state variables from the other compartment from the stack, and pushing the state variable output to the stack.

In Example 29, the subject matter of any one or more of Examples 26-28 optionally include wherein the operations include stack operations, the join operations, threshold operations, backward action potential (bAP) operations, mathematical operations, and Boolean logic operations.

In Example 30, the subject matter of any one or more of Examples 26-29 optionally include executing through a hierarchical dendritic tree structure from the dendritic compartments being processed; and producing a spiking event from only the highest level value.

What is claimed is:

1. An electronic neural core circuit, comprising:
a plurality of neural compartments that are collectively serviced over time to evolve respective compartment states, wherein each servicing corresponds to a neuromorphic time step, and each compartment comprises a state variable representing a state of the neural compartment;
wherein the neural core circuit is configured to perform operations to, for a neural compartment during the neuromorphic time step: a) receive a synaptic input; b) perform a state variable operation utilizing: 1) a stored state variable that was stored in the neural compartment prior to receipt of the synaptic input, and 2) the synaptic input, thereby producing a state variable result; c) perform a join operation utilizing: 1) the state variable result, 2) input from a state variable from an other compartment that has been previously processed, and 3) a join operation configuration that is stored in or associated with the neural compartment, thereby producing a join operation result; and d) produce a state variable output based on the join operation.

2. The circuit of claim 1, wherein the neural core circuit is further configured to produce a spike-related output if the join operation result reaches a spiking threshold.

3. The circuit of claim 2, wherein the spike-related output is an actual spike event.

4. The circuit of claim 2, wherein the spike-related output is a spiking state value only, that is a part of the state variable output.

5. The circuit of claim 1, wherein:
the neural core circuit is further configured to utilize a stack; and
the join operations include stack operations to communicate state variables from one dendritic compartment to a different dendritic compartment.

6. The circuit of claim 5, wherein:
the stack operations include push and pop; and
the neural core circuit is further configured to pop input from the state variables from the other compartment from the stack, and to push the state variable output to the stack.

7. The circuit of claim 1, wherein the operations include stack operations, the join operations, threshold operations, backward action potential (bAP) operations, mathematical operations, and Boolean logic operations.

8. The circuit of claim 1, wherein the neural core circuit is further configured to, upon completion of operation (d) for a first neural compartment, perform operations (a)-(d) for a second neural compartment, wherein at least one variable output of the first neural compartment is at least one of the variables from the other compartment in the second neural compartment.

9. The circuit of claim 8, wherein the neural core circuit is further configured to execute through a hierarchical dendritic tree structure from the dendritic compartments it processes and produce a spiking event from only a highest dendritic compartment of the dendritic tree structure.

10. The circuit of claim 9, wherein the neural core circuit is further configured to generate a backward action potential (bAP) that executes through the hierarchical dendritic tree structure in a reverse order, based on the spiking event.

11. The circuit of claim 10, wherein the neural core circuit is further configured to communicate the bAP, including its implicit spike time or spike time dependent state variable, to all fan-in synapses of all dendritic compartments that receive synaptic input.

12. The circuit of claim 10, wherein the neural core circuit is further configured to change one or more parameters associated with a neuron model of a dendritic compartment itself in response to a backward action potential (bAP) or forward going spikes or spiking state values.

13. The circuit of claim 12, wherein one of the parameters is a spiking threshold.

14. The circuit of claim 13, wherein the one or more parameters include at least the spiking threshold, state variable exponential decay time constants, current bias constants, scaling constants applied to synaptic inputs, and scaling constants applied to join operation inputs.

15. The circuit of claim 8, wherein the neural core circuit is further configured to concurrently process a plurality of dendritic compartments.

16. The circuit of claim 1, wherein:
the state variable is a first state variable;
the neural compartment comprises a second state variable representing a second state of the neural compartment;
the neural core circuit is further configured to perform operations to, for a neural compartment during the neuromorphic time step:
e) perform a second state variable operation utilizing: 1) a stored second state variable that was stored in the memory prior to receipt of the synaptic input, and 2) the first join operation, thereby producing a second state variable result; and
f) perform a second join operation utilizing: 1) the second state variable result, 2) input from a second state variable from the other compartment that has been previously processed, and 3) join operation configuration that is stored in the memory associated with the neural compartment, thereby producing a second join operation result; and
wherein the producing of the state variable output is further based on the second join operation.

17. A method executed by a processor of an electronic neural core circuit, comprising:
during a neuromorphic time step:
a) receiving a synaptic input at a dendritic compartment;
b) performing a state variable operation utilizing: 1) a stored state variable that was stored in the memory prior to receipt of the synaptic input, and 2) the synaptic input, thereby producing a state variable result;
c) performing a join operation utilizing: 1) the first state variable result, 2) input from a first state variable from an other compartment that has been previously processed, and 3) join operation configuration that is stored in the memory associated with the neural compartment, thereby producing a first join operation result; and
d) producing a state variable output based on the join operation.

18. The method of claim 17, further comprising operating using a stack, and communicating state variables from one dendritic compartment to a different dendritic compartment using stack operations in the join operations.

19. The method of claim 18, further comprising popping input from the state variables from the other compartment from the stack, and pushing the state variable output to the stack.

20. The method of claim 17, wherein the operations include stack operations, the join operations, threshold operations, backward action potential (bAP) operations, mathematical operations, and Boolean logic operations.

21. The method of claim 17, further comprising:
executing through a hierarchical dendritic tree structure from the dendritic compartments being processed; and
producing a spiking event from only the highest level value.

22. At least one machine-readable storage medium, comprising a plurality of instructions adapted for execution within an electronic neural core circuit, wherein the instructions, responsive to being executed with the neural core circuit of a computing machine, cause the computing machine to perform operations that:
during a neuromorphic time step:
a) receive a synaptic input at a dendritic compartment;
b) perform a state variable operation utilizing: 1) a stored state variable that was stored in the memory prior to receipt of the synaptic input, and 2) the synaptic input, thereby producing a state variable result;
c) perform a join operation utilizing: 1) the first state variable result, 2) input from a first state variable from an other compartment that has been previously processed, and 3) join operation configuration that is stored in the memory associated with the neural compartment, thereby producing a first join operation result; and
d) produce a state variable output based on the join operation.

23. The at least one machine readable medium of claim 22, wherein the instructions are further operable to configure the circuit to utilize a stack and the join operations include stack operations to communicate state variables from one dendritic compartment to a different dendritic compartment, wherein the stack operations include push and pop, and the processor is further configured to pop input from the state variables from the other compartment from the stack, and to push the state variable output to the stack.
